(19) United States
(12) Patent Application Publication
(10) Pub. No.: US 2005/0023498 A1
(43) Pub. Date: Feb. 3, 2005

(54) Servo-assisted butterfly valve provided with a compression spring to stabilise the limp-home positions

(76) Inventors: Salvatore Vutera Cuda, Sant 'Agata Bolognese (IT); Luciano Isopi, Roma (IT); Domenico Cannone, Bologna (IT)

Correspondence Address: HOWREY SIMON ARNOLD & WHITE LLP, 750 BERING DRIVE, HOUSTON, TX, 77057, US

(21) Appl. No.: 10/883,606

(22) Filed: Jul. 1, 2004

(30) Foreign Application Priority Data
Jul. 1, 2003 (IT) BO2003A 000406

(51) Int. Cl. F16K 51/00

(52) U.S. Cl. 251/305

(57) ABSTRACT

A butterfly valve comprising a valve seat, a butterfly body engaging the valve seat, a shaft on which the butterfly body is keyed, an electric actuator coupled to the shaft, a torsional return spring adapted to rotate the butterfly body towards a closed position, a compression abutment spring adapted to rotate the butterfly body towards an open position, and an abutment body which causes the action of the abutment spring to stop when the butterfly body is in a limp-home position; the abutment spring having a mechanically fixed end connected to the valve body and a mechanically moving end connected to a wheel rigid with the shaft by means of the interposition of a transmission member mounted to slide within a chamber housing the abutment spring.

### CROSS REFERENCE TO RELATED APPLICATIONS

The present application claims priority to Italian Patent Application Serial No. BO2003A 000406 filed Jul. 1, 2003.

### FIELD OF THE INVENTION

The present invention relates to a servo-assisted butterfly valve for an internal combustion engine.

### DESCRIPTION OF RELATED ART

In an internal combustion engine, the function of a butterfly valve is to regulate the flow of fresh air supplied to the cylinders; a butterfly valve of known type comprises a valve body housing a valve seat engaged by a butterfly body which is keyed on a shaft in order to rotate between a position of maximum opening and a closed position of the valve seat under the action of an electric actuator coupled to this shaft by means of a geared transmission. A torsional return spring acts on the shaft (i.e. the spring is deformed with a circular displacement generating a resistance torque), which is mounted coaxially to the shaft and is mechanically coupled to the shaft in order to exert a torque on the shaft which tends to bring it into the closed position; the shaft is also acted upon by a torsional opposing spring which is mounted coaxially to the shaft in order to exert a torque on this shaft which tends to bring the shaft into a partially open position (called the limp-home position) against the action of the return spring and as a result of the presence of an abutment surface which defines a stop for the opposing spring against which the opening movement caused by this opposing spring is stopped. The torque generated by the opposing spring is greater than the torque generated by the return spring; for this reason, when the engine is not actuated, the shaft is disposed in the limp-home position and the engine itself then has to generate a respective drive torque either to bring the shaft into the position of maximum opening or to bring the shaft into the closed position.

At present, the abutment surface is formed by a support body which is obtained by casting on the crude valve body; however, the sum of the tolerances in respect of the cast machining, the co-moulding of the shaft, the diameter of the butterfly body and the diameter of the valve seat determines a total dispersion of the air flow in the limp-home position of ±18-20%. In some applications, this total air flow dispersion value in the limp-home position is too high; it has therefore been proposed to carry out precision machining on the support body, which precision machining makes it possible to reduce the total air flow dispersion value in the limp-home position to approximately ±10-12%.

However, this precision machining is particularly costly and does not, moreover, make it possible to obtain a total air flow dispersion value in the limp-home position of less than ±10%. Moreover, in order to significantly to vary the value of the air flow in the limp-home position (typically to adapt the butterfly valve to different types of engine), it is necessary to modify the casting mould to vary the position of the support body; in general, a specific valve body and therefore a specific mould is required for each flow value with an evident increase in production costs.

In order to try further to reduce the total air flow dispersion value in the limp-home position it has been proposed to replace the support body with a screw which is screwed through the valve body and has a head disposed outside the valve body and a free end which forms the abutment surface. During the production phase, each butterfly valve is disposed in a test bench in which the value of the air flow in the limp-home position is measured in real time; in these conditions, the axial position of the screw is adjusted by screwing or unscrewing this screw with respect to the valve body in order accurately to obtain the desired air flow value in the limp-home position. Preferably, once the axial position of the screw has been adjusted, the screw itself is locked with respect to the valve body in order to prevent any type of subsequent displacement (typically as a result of the vibrations generated when the engine is operating).

However, even the use of this through screw does not make it possible significantly to vary the value of the air flow in the limp-home position without modifying the casting mould.

### SUMMARY OF THE INVENTION

The object of the present invention is to provide a servo-assisted butterfly valve which is free from the drawbacks mentioned above and which is, in particular, easy and economic to embody.

The present invention therefore relates to a servo-assisted butterfly valve for an internal combustion engine comprising a valve body, a valve seat formed in the valve body, a butterfly body adapted to engage the valve seat, a shaft on which the butterfly body is keyed, an electric actuator coupled to the shaft in order to rotate the butterfly body between a position of maximum opening and a closed position of the valve seat, a first elastic body adapted to rotate the butterfly body towards the closed position, a second elastic body adapted to rotate the butterfly body towards an open position, and an abutment body which causes the action of the second elastic body to stop when the butterfly body is in a partially open or limp-home position, the butterfly valve being characterized in that the second elastic body is a compression spring and has a mechanically fixed end connected to the valve body and a mechanically moving end connected to a wheel rigid with the shaft by means of the interposition of a transmission member mounted to slide within a first chamber housing the second elastic body, the abutment body being rigid with the first chamber and being adapted to limit the stroke of the transmission member along this first chamber.

### DESCRIPTION OF THE FIGURES

The present invention is described below with reference to the accompanying drawings, which show a non-limiting embodiment thereof, and in which:

FIG. 1 is a diagrammatic front view, with some parts removed for clarity, of a servo-assisted butterfly valve of the present invention provided with a device for adjusting the limp-home position shown in section;

FIG. 2 is a perspective view of a detail of FIG. 1;

FIGS. 3 and 4 are front views of an alternative embodiment of the device for adjusting the limp-home position of the butterfly valve of FIG. 1 in two different operating configurations;

FIGS. 5 and 6 are front views of a further embodiment of the device for adjusting the limp-home position of the butterfly valve of FIG. 1 in two different operating configurations;

FIG. 7 is a perspective view, on an enlarged scale, of an electric actuator of the butterfly valve of FIG. 1;

FIG. 8 is a view of a lower surface of a fastening plate of the electric actuator of FIG. 7.

### DETAILED DESCRIPTION OF THE INVENTION

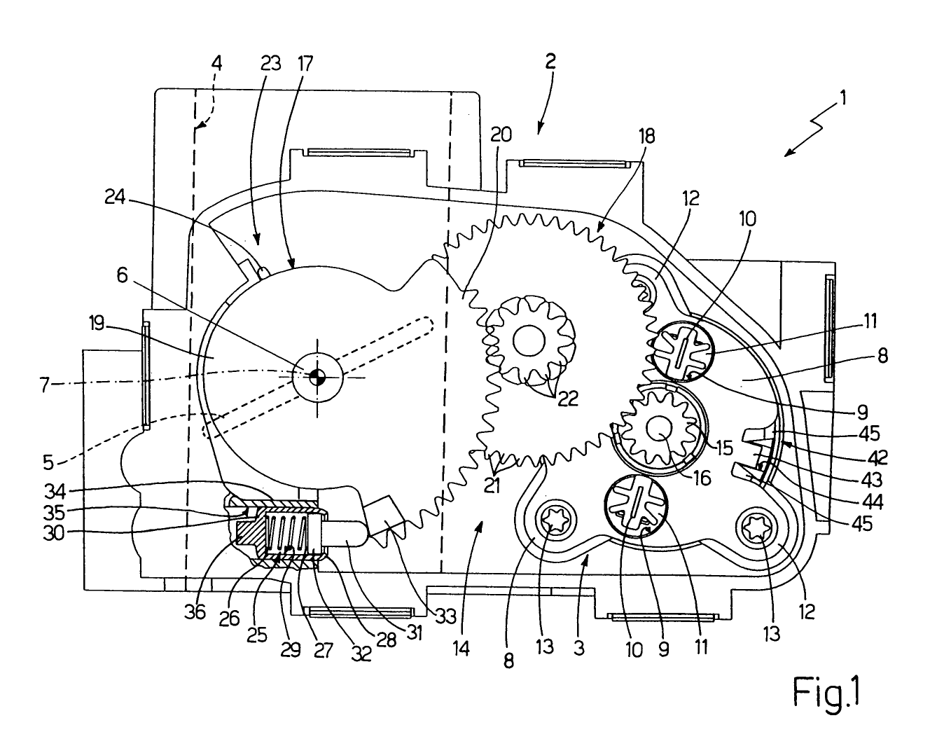

In FIG. 1, a servo-assisted butterfly valve for an internal combustion engine is shown overall by 1; the butterfly valve 1 comprises a valve body 2 which houses an electric actuator 3, a cylindrical valve seat 4 (shown diagrammatically in dashed lines) and a butterfly body 5 (shown diagrammatically in dashed lines) which engages the valve seat 4 and is displaced between a position of maximum opening and a closed position of the valve seat 4 under the action of the electric actuator 3. The butterfly body 5 is keyed on a metal shaft 6 which is mounted on the valve body 2 in order to rotate about a longitudinal axis 7 under the action of the electric actuator 3 in order to displace the butterfly body 5 between the above-mentioned position of maximum opening and the above-mentioned closed position of the valve seat 4.

The electric actuator 3 comprises a cylindrical body which is inserted in a corresponding cylindrical seat obtained in the valve body 2 and is held in position within its cylindrical seat by means of a metal plate 8 provided with a pair of through holes 9 via which two electrical conductors 10 pass and supply electrical energy to the electric actuator 3; a respective insulating bushing 11 is interposed between each electrical conductor 10 and the respective hole 9 of the plate 8. The main function of the plate 8 is to enable the electric actuator 3 to be fastened to the valve body 2; for this purpose, the plate 9 has three radial drilled projections 12, via which respective screws 13 for fastening to the valve body 2 are inserted.

The electric actuator 3 transmits movement to the shaft 6 by means of a geared transmission 14 which comprises a toothed wheel 15 keyed on the shaft 16 of the electric actuator 3, a toothed wheel 17 keyed on the shaft 6 and an idle toothed wheel 18 interposed between the toothed wheel 15 and the toothed wheel 17. The toothed wheel 17 has a solid central cylindrical body 19 which is keyed on the shaft 6 and is provided with a circular crown portion 20 which has a series of teeth coupled to the toothed wheel 18. The toothed wheel 18 has a first series of teeth 21 coupled to the toothed wheel 15 and a second series of teeth 22 coupled to the toothed wheel 17; the diameter of the first series of teeth 21 differs from the diameter of the second series of teeth 22 and therefore the toothed wheel 18 determines a transmission ratio which is not unitary. Normally, the toothed wheel 17 and the toothed wheel 18 are made from plastic material, while the toothed wheel 15 is made from metal material.

The shaft 6 is coupled to a return spring 23, which is a torsional spring (i.e. the spring is deformed with a circular displacement generating a resistance torque) and has an end (not shown) connected to the shaft 6 and an end 24 connected to the valve body 2. The shaft 6 is also coupled to an opposing spring 25, which is a compression spring (i.e. the spring is deformed with a linear displacement causing a resistance force) and has a mechanically fixed end 26 connected to the valve body 2 and a mechanically moving end 27 connected to the shaft 6 via the circular crown portion 20 of the toothed wheel 17.

The return spring 23 tends to rotate the shaft 6 in the clockwise direction with a movement which tends to bring the butterfly body 5 towards the closed position, while the opposing spring 25 tends to rotate the shaft 6 in the anticlockwise direction with a movement which tends to bring the butterfly body 5 towards an open position; the return spring 23 generates a torque smaller than the torque generated by the opposing spring 25, and therefore, in overall terms, the combination of the effects of the return spring 23 and the opposing spring 25 tends to rotate the shaft 6 in the anticlockwise direction towards an open position. The anticlockwise rotation towards the open position of the shaft 6 under the action of the return spring 23 and the opposing spring 25 is stopped by the presence of an abutment body 28 which forms an abutment surface against the expansion of the opposing spring 25; in this way, when the electric actuator 3 is not actuated, the shaft 6 (and therefore the butterfly body 5) is disposed in a partially open or limp-home position (shown in FIG. 1).

When the electric actuator 3 is actuated, the drive torque generated by the electric actuator 3 on its own shaft 16 is able to rotate the shaft 6 (and therefore the butterfly body 5) into the above-mentioned closed position against the torque generated by the abutment spring 25 and is able to rotate the shaft 6 (and therefore the butterfly body 5) into the above-mentioned position of maximum opening against the torque generated by the return spring 23.

The valve body 2 comprises a cylindrical chamber 29 which houses the opposing spring 25; the chamber 29 is bounded on one side by a stop member 30 against which the fixed end 26 of the opposing spring 25 bears, and the chamber 29 is bounded on the other side by a transmission member 31 having a base 32 against which the moving end 27 of the opposing spring 25 bears; the transmission member 31 is mounted to slide within the chamber 29 between two extremes formed by the stop member 30 and the abutment body 28 which is shaped as an annular body against which the base 32 of the transmission member 31 bears. In operation, the transmission member 31 bears against a projection 33 of the circular crown portion 20 of the toothed wheel 17 when the position of the shaft 6 is between the closed position and the limp-home position. It is important to note than the opposing spring 25 is pre-loaded within the chamber 29 such that, as mentioned above, the torque generated on the shaft 6 by the opposing spring 25 is greater than the torque generated on the shaft 6 by the return spring 23.

The chamber 29 is obtained within a cylindrical tubular body 34 which is in turn inserted in a further cylindrical chamber 35 obtained directly in the valve body 2 and comprises the stop member 30; the lateral outer surface of the tubular body 34 comprises a thread which engages with an equivalent thread in the inner surface of the chamber 35; in this way, the axial position of the tubular body 34 within the chamber 35 may be adjusted by screwing or unscrewing the tubular body 34. For this purpose, a wall 36 of the stop member 30 disposed outside the chamber 29 is shaped such that it can be engaged by a device adapted to screw or unscrew the tubular body 34.

During the production phase, the butterfly valve 1 is disposed in a known test bench (not shown) in which the value of the air flow in the limp-home position is measured in real time; in these conditions, the axial position of the tubular body 34 in the chamber 35 is adjusted by screwing or unscrewing this tubular body 34 until the desired value of the air flow in the limp-home position is accurately obtained. Preferably, once the axial position of the tubular body 34 has been adjusted within the chamber 35, the tubular body 34 is locked with respect to the chamber 35 to prevent any subsequent type of displacement (typically as a result of the vibrations generated when the engine is operating).

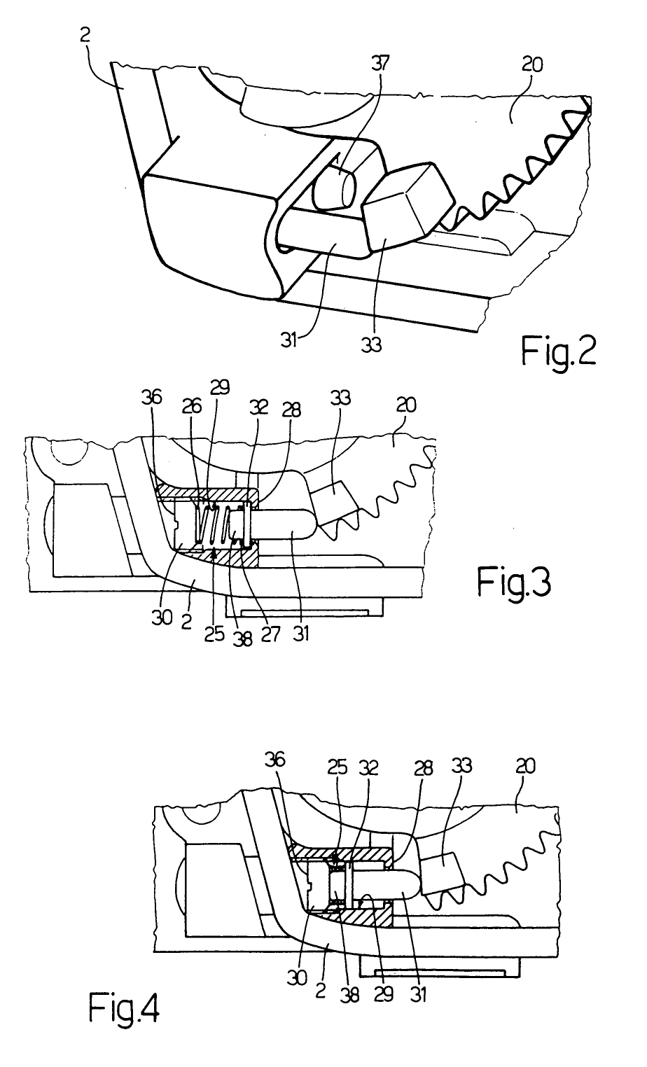

As shown in FIG. 2, an idling screw 37 having an anti-jam function with respect to the butterfly body 5 is provided and cooperates with the circular crown portion 20 of the toothed wheel 17; when the shaft 6 is brought into the closed position under the action of the electric actuator 3, the rotation of the shaft 6 is not stopped by the impact between the butterfly body 5 and the walls of the valve seat 4, but is stopped by the impact of the circular crown portion 20 of the toothed wheel 17 against the idling screw 37. This solution is necessary as a result of the fact that a possible impact between the butterfly body 5 and the walls of the valve seat 4 could cause the butterfly body 5 to be wedged with respect to the walls of the valve seat 4 and therefore could jam the butterfly valve 1. During the production phase of the butterfly body 1, the axial position of the idling screw 37 may be adjusted by screwing or unscrewing the idling screw 37 with respect to the valve body 2; the position of the idling screw 37 may then be locked with respect to the valve body 2 to prevent any type of subsequent displacement (typically as a result of the vibrations generated by the operation of the engine).

FIGS. 3 and 4 show a different embodiment of the chamber 29 which is obtained directly in the valve body 2; the stop member 30 has on its lateral surface a thread which engages with an equivalent thread present on the inner surface of the chamber 29; in this way, the axial position of the stop member 30 within the chamber 29 may be adjusted by screwing or unscrewing this stop member 30. For this purpose, the wall 36 of the stop member 30 disposed outside the chamber 29 is shaped such that it can be engaged by a device (known and not shown) adapted to screw or unscrew the stop member 30. Moreover, the transmission member 31 comprises a projection 38 which extends inside the chamber 29 from the base 32 of the transmission member 31 towards the stop member 30 and is disposed within the opposing spring 25.

The projection 38 of the transmission member 31 performs an anti-jam function with respect to the butterfly body 5 in place of the idling screw 37 which is omitted from this embodiment. FIG. 3 shows the configuration assumed by the transmission member 31 when the butterfly body 5 is in the limp-home position; FIG. 4 shows the configuration assumed by the transmission member 31 when the butterfly body 5 is in the closed position: it can be seen that the abutment of the projection 38 of the transmission member 31 against the stop member 30 causes the rotation of the circular crown portion 20 of the toothed wheel 17, and therefore of the shaft 6 and the butterfly body 5, to stop, in a manner entirely similar to that of the idling screw 37 included in the embodiment of FIGS. 1 and 2. By screwing or unscrewing the stop member 30 with respect to the chamber 29 it is possible to adjust the axial position of this stop member 30 within the chamber 29 and therefore possible to adjust the closed position determined by the abutment of the projection 38 of the transmission member 31 against the stop member 30.

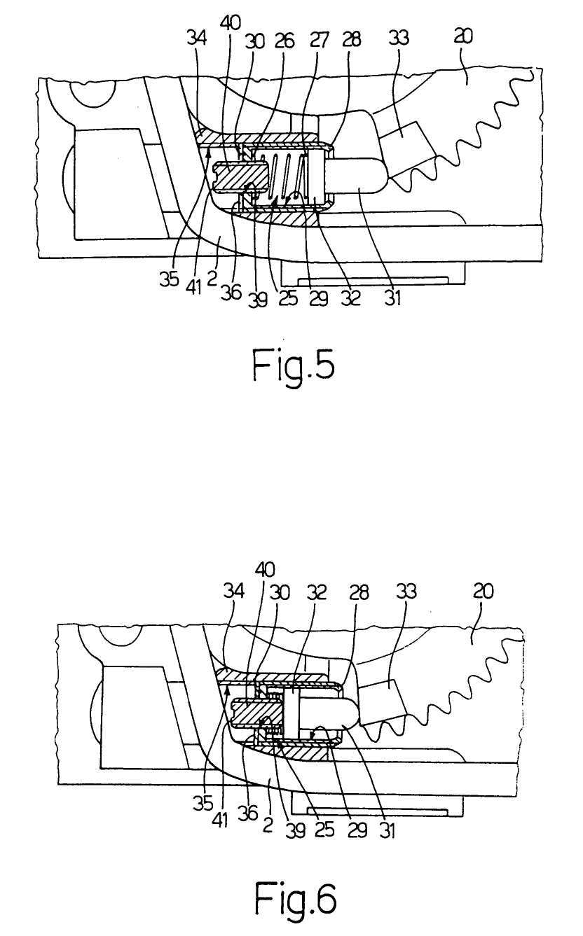

FIGS. 5 and 6 show a further embodiment of the chamber 29, in which the regulation of the limp-home position contained in the embodiment illustrated in FIGS. 1 and 2 is combined with the anti-jam function contained in the embodiment illustrated in FIGS. 3 and 4. As shown in FIGS. 5 and 6, the stop member 30 has a central through hole 39 which is threaded and engaged by an idling pin 40 of cylindrical shape; the idling pin 40 is externally threaded so that the axial position of the idling pin 40 with respect to the stop member 30 may be regulated by screwing or unscrewing this idling pin 40. The idling pin 40 extends partially within the chamber 29 so as to be disposed within the opposing spring 25 and to define a stop abutment as regards the displacement of the transmission member 31.

The idling pin 40 performs the anti-jam function with respect to the butterfly body 5 in place of the idling screw 37 which is omitted from this embodiment. FIG. 5 shows the configuration assumed by the transmission member 31 when the butterfly body 5 is in the limp-home position; FIG. 6 shows the configuration assumed by the transmission member 31 when the butterfly body 5 is in the closed position; it can be seen that the abutment of the transmission member 31 against the idling pin 40 causes the rotation of the circular crown portion 20 of the toothed wheel 17, and therefore of the shaft 6 and the butterfly body 5, to stop, in a manner entirely similar to that of the idling screw 37 in the embodiment shown in FIGS. 1 and 2. By screwing or unscrewing the idling pin 40 with respect to the stop member 30, it is possible to adjust the axial position of the idling pin 40 within the chamber 29 and therefore possible to adjust the closed position determined by the abutment of the transmission member 31 against the idling pin 40.

As mentioned above, the axial position of the tubular body 34 within the chamber 35 may be adjusted by screwing or unscrewing the tubular body 34 in order to vary the value of the air flow in the limp-home position.

In order to make it possible to regulate both the axial position of the tubular body 34 in the chamber 35 and the axial position of the idling pin 40 within the chamber 29, a base 41 of the idling pin 40 disposed outside the chamber 29 is shaped such that it can be engaged by a first device adapted to screw or unscrew the idling pin 40, while the portion of the wall 36 of the stop member 30 disposed about the hole 39 is shaped such that it can be engaged by a second device adapted to screw or unscrew the tubular body 34.

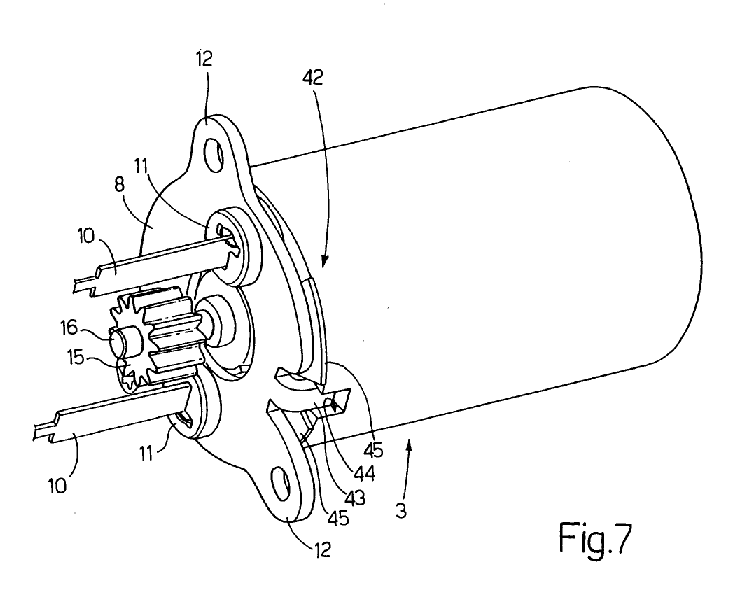

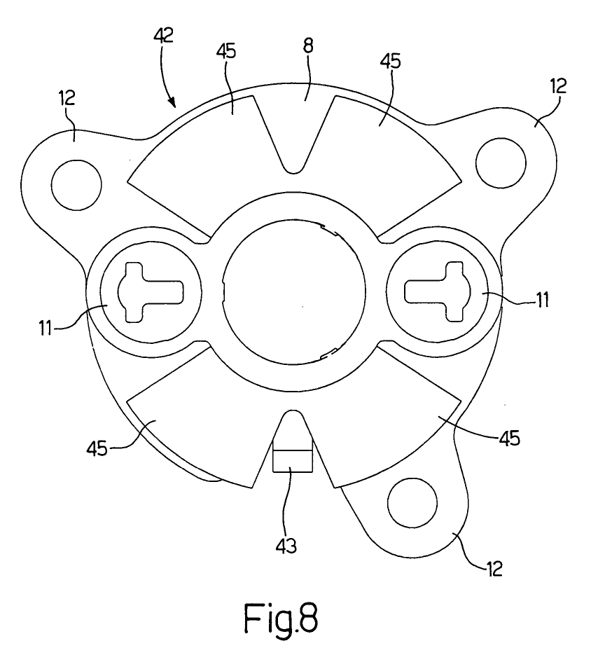

As shown in FIG. 7, a cup spring 42 which exerts a predetermined axial force on the electric actuator 3 in order to maintain this electric actuator 3 in its working position is interposed between the plate 8 and the electric actuator 3; the spring 42 is preferably mechanically connected to the plate 8 by a coupling of polymer material moulded simultaneously with the injection moulding of the bushings 11. The function of the spring 42 is to maintain the electric actuator 3 in position with a predetermined force making it possible at the same time to offset the axial constructional tolerances. Moreover, the plate 8 has a projection 43 which is adapted to engage a corresponding seat 44 in the container of the electric actuator 3 so as to determine a correct relative positioning between the plate 8 and the electric actuator 3. As shown in FIG. 8, the cup spring 42 has four projections 45 which, in operation, are axially deformed by the electric actuator 3 and therefore generate an elastic feedback force axially directed on this electric actuator 3.

The butterfly valve 1 described above has a range of advantages, since the air flow in the limp-home position can be adjusted in a simple and precise manner by varying the axial position of the tubular body 34 within the chamber 35; moreover, it is readily possible to obtain different air flow values in the limp-home position by the simple substitution of the transmission member 31 (a longer transmission member 31 causes a greater air flow in the limp-home position and a shorter transmission member 31 causes a smaller air flow in the limp-home position). Lastly, in the embodiments of FIGS. 3 to 6, the idling screw 37 is no longer needed with obvious advantages in terms of cost and constructional simplicity.

1. A servo-assisted butterfly valve (1) for an internal combustion engine comprising a valve body (2), a valve seat (4) formed in the valve body (2), a butterfly body (5) adapted to engage the valve seat (4), a shaft (6) on which the butterfly body (5) is keyed, an electric actuator (3) coupled to the shaft (6) in order to rotate the butterfly body (5) between a position of maximum opening and a closed position of the valve seat (4), a first elastic body (23) adapted to rotate the butterfly body (5) towards the closed position, a second elastic body (25) adapted to rotate the butterfly body (5) towards an open position, and an abutment body (28) which causes the action of the second elastic body (25) to stop when the butterfly body (5) is in a partially open or limp-home position, the butterfly valve (1) being characterized in that the second elastic body (25) is a compression spring and has a mechanically fixed end (26) connected to the valve body (2) and a mechanically moving end (27) connected to a wheel (17) rigid with the shaft (6) by means of the interposition of a transmission member (31) mounted to slide within a first chamber (29) housing the second elastic body (25), the abutment body (28) being rigid with the first chamber (29) and being adapted to limit the stroke of the transmission member (31) along this first chamber (29).

2. The valve (1) of claim 1, in which a geared transmission (14) is provided and is adapted to transmit movement from the electric actuator (3) to the shaft (6) and comprises the wheel (17) mechanically connected to the moving end (27) of the second elastic body (25).

3. The valve (1) of claim 2, in which the wheel (17) comprises a circular crown portion (20) which is provided with a series of teeth and is mechanically connected to the moving end (27) of the second elastic body (25).

4. The valve (1) of claim 1, in which the first chamber (29) is bounded by a stop member (30) against which the fixed end (26) of the second elastic body (25) bears, and by the transmission member (31) having a base (32) against which the moving end (27) of the second elastic body (25) bears, the abutment body (28) being shaped as an annular body against which the base (32) of the transmission member (31) abuts.

5. The valve (1) of claim 1, in which the valve body (2) comprises a second cylindrical chamber (35) and a tubular cylindrical body (34) which is inserted in the second chamber (35) and houses the first chamber (29), the outer lateral surface of the tubular body (34) having a thread which meshes with an equivalent thread present on the inner surface of the second chamber (35).

6. The valve (1) of claim 5, in which the first chamber (29) is bounded by a stop member (30) against which the fixed end (26) of the second elastic body (25) bears, and by the transmission member (31) having a base (32) against which the moving end (27) of the second elastic body (25) bears, the stop member (30) having a central through hole (39) which is threaded and engaged by a pin (40) of cylindrical shape which is externally threaded and extends partially inside the first chamber (29) in order to limit the stroke of the transmission member (31) along the first chamber (29) on the opposing side with respect to the abutment body (28).

7. The valve (1) of claim 6, in which the pin (40) is disposed within the opposing spring (25).

8. The valve (1) of claim 6, in which, in order to enable adjustment of both the axial position of the tubular body (34) within the second chamber (35) and the axial position of the pin (40) within the first chamber (29), a base (41) of the pin (40) disposed outside the first chamber (29) is shaped such that it can be engaged by a first device adapted to screw or unscrew the pin (40) and the portion of the stop member (30) disposed about the central hole (39) is shaped such that it can be engaged by a second device adapted to screw or unscrew the tubular body (34).

9. The valve (1) of claim 1, in which the first chamber (29) is bounded by a stop member (30) against which the fixed end (26) of the second elastic body (25) bears, and by the transmission member (31) having a base (32) against which the moving end (27) of the second elastic body (25) bears, the transmission member (31) comprising a projection (38) which extends inside the first chamber (29) from the base (32) of the transmission member (31) towards the stop member (30) and is adapted to limit the stroke of the transmission member (31) along the first chamber (29) on the opposing side with respect to the abutment body (28).

10. The valve (1) of claim 9, in which the stop member (30) has, at the location of its lateral surface, a thread which engages with an equivalent thread present on the inner surface of the chamber (29), a wall (36) of the stop member (30) disposed outside the first chamber (29) being shaped such that it can be engaged by a device adapted to screw or unscrew this stop member (30).

11. The valve (1) of claim 9, in which the projection (38) of the transmission member (31) is disposed within the opposing spring (25).

12. The valve (1) of claim 9, in which the first chamber (29) is obtained directly in the valve body (2).

13. The valve (1) of claim 1, in which the electric actuator (3) comprises a cylindrical body which is inserted in a corresponding cylindrical seat obtained in the valve body (2) and is held in position in its cylindrical seat by a metal plate (8) provided with a pair of through holes (9) via which two electrical conductors (10) pass and supply electrical energy to the actuator (3), a spring (42) exerting a predetermined axial force on the electric actuator (3) to maintain this electric actuator (3) in a predetermined position within its seat being interposed between the plate (8) and the electric actuator (3).

14. The valve (1) of claim 13, in which the spring (42) is a cup spring.

15. The valve (1) of claim 14, in which the cup spring (42) has four projections (45) which, in use, are axially deformed by the electric actuator (3) and thus generate an elastic feedback force axially directed on this electric actuator (3).

16. The valve (1) of claim 15, in which two respective bushings (11) of plastic material are interposed between the conductors (10) and the holes (9) of the plate (8), each bushing (11) being produced by injection moulding of the plastic material directly on the plate (8), coupling the plate itself (8) with an appropriate mould, the spring being mechanically connected to the plate (8) by means of a coupling of plastic material moulded simultaneously with the injection moulding of the bushings (1).
